(19) United States
(12) Patent Application Publication
(10) Pub. No.: US 2025/0263276 A1
(43) Pub. Date: Aug. 21, 2025

(54) Transmission Hoist Device

(71) Applicant: Robert Laumann, Cincinnati, OH (US)

(72) Inventor: Robert Laumann, Cincinnati, OH (US)

(21) Appl. No.: 19/001,785

(22) Filed: Dec. 26, 2024

Related U.S. Application Data
(60) Provisional application No. 63/554,207, filed on Feb. 16, 2024.

(51) Int. Cl. B66F 3/36

(52) U.S. Cl. CPC B66F 3/36

(57) ABSTRACT

A transmission hoist device is disclosed for converting an engine hoist and a transmission jack into a transmission hoist device. The transmission hoist device comprises a conventional transmission jack with, for example, a 2″×2″ sleeve that slides around a boom of an engine hoist. The steel adapter slides into the arm of the hoist and features an adjustable plate to hold a transmission for removal, repair, and/or replacement. Thus, the transmission hoist device combines a transmission jack and an engine hoist into one convenient tool.

### CROSS-REFERENCE TO RELATED APPLICATION

The present application claims priority to, and the benefit of, U.S. Provisional Application No. 63/554,207, which was filed on Feb. 16, 2024, and is incorporated herein by reference in its entirety.

### FIELD OF THE INVENTION

The present invention relates generally to the field of transmission hoist and jack devices. More specifically, the present invention relates to a device that converts an engine hoist into a transmission jack. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in transmission hoist and jack devices. Generally, standard transmission jacks have a small base and a center of gravity that is too high, making it difficult and inconvenient for users to work on a transmission system. The jack will not elevate high enough to accommodate a fully elevated vehicle, forcing the user to bend down into an awkward and uncomfortable position to work on the transmission. This repetitive bending of the body can cause pain and even injury if repeated over a mechanic's entire career. Traditional transmission jacks are also large, bulky, and take up significant space within an automotive shop or garage, inconveniencing users further by having to work around them during other tasks.

Accordingly, there is a demand for an improved transmission hoist device that provides users with a conversion system for an engine hoist, transforming it into a transmission jack. More particularly, there is a demand for a transmission hoist device that saves considerable time and effort when performing vehicle maintenance.

Therefore, there exists a long felt need in the art for a transmission hoist device that provides users with a means to convert an engine hoist into a transmission jack. There is also a long felt need in the art for a transmission hoist device that can be elevated much higher and is much more stable than a conventional transmission jack. Further, there is a long felt need in the art for a transmission hoist device that enables mechanics to work on the transmission without bending over into awkward and uncomfortable positions. Finally, there is a long felt need in the art for a transmission hoist device that saves time and effort during vehicle maintenance work.

The subject matter disclosed and claimed herein, in one embodiment thereof, comprises a transmission hoist device. The device is a means of converting an engine hoist into a transmission jack. The transmission hoist device comprises a conventional transmission jack with, for example, a 2″×2″ sleeve that slides into the end of an engine hoist. The steel sleeve slides into the arm of the hoist and features an adjustable plate to hold a transmission for removal, repair, and/or replacement. Accordingly, the device combines a transmission jack and an engine hoist into one convenient tool.

In this manner, the transmission hoist device of the present invention accomplishes all of the forgoing objectives and provides users with a device that enables for faster and easier vehicle maintenance.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a transmission hoist device. The device is a tool that converts an engine hoist into a transmission jack. The transmission hoist device comprises a conventional transmission jack with a, for example, 2″×2″ sleeve that slides into the end of an engine hoist. Thus, once the steel sleeve slides into the arm of the hoist, the engine hoist is effectively converted into a transmission jack. The steel sleeve slides into the arm of the hoist and features an adjustable plate to hold a transmission for removal, repair, and/or replacement.

In one embodiment, the transmission hoist device of the present invention assists any setting in which vehicle maintenance is performed. The transmission hoist device secures easily to an engine hoist and converts it into a transmission jack. The transmission hoist device provides for a higher elevation that is much more stable than a conventional transmission jack. The transmission hoist device enables mechanics to work on the transmission without bending over into awkward and uncomfortable positions. The device saves considerable time and effort when performing vehicle maintenance.

In one embodiment, the transmission hoist device comprises a standard transmission jack. The body component is typically configured as a conventional transmission jack but can be configured in any suitable size or shape as is known in the art. The transmission hoist device also utilizes the boom of an engine hoist. The transmission jack comprises, for example, a 2″×2″ sleeve that slides onto the boom of an engine hoist, combining the two tools. A sleeve securement knob is tightened to secure the sleeve onto the boom.

In one embodiment, the steel sleeve that slides onto the arm of the hoist features an adjustable plate that holds a transmission system for removal, repair, and/or replacement. The adjustable plate features two tilt adjustment knobs to modify the angle of the transmission and enable for a more comfortable workflow.

In one embodiment, the transmission hoist device features steel chains that are used to further secure a transmission system onto the adjustable plate of the device.

In one embodiment, the sleeve securement knob and tilt adjustment knobs are used to secure the sleeve onto the boom and adjust the angle of the device, respectively. It is to be appreciated that any other suitable fasteners or adjustment means as is known in the art may be used.

In one embodiment, the transmission hoist device in accordance with the present invention can be produced in various colors, designs, patterns, etc., and feature logos, emblems and or designs, such as a garage requests and/or a user desires.

In one embodiment, the transmission hoist device is manufactured of steel, or any other suitable materials as is known in the art. Any number of different types of materials can be used to make the transmission hoist device including but not limited to titanium, iron, carbon steel, metal alloys, etc.

In use, the user slides the sleeve of the transmission jack into the boom of the engine hoist and tightens the sleeve securement knob. The user then removes the transmission system from a vehicle and secures it to the adjustable plate of the transmission hoist device. The user can then adjust the working angle of the transmission system via the tilt adjustment knobs. Finally, the user can utilize the transmission hoist device to perform transmission system maintenance. In this manner, the user is provided with a conversion system for an engine hoist, transforming it into a transmission jack that can be elevated much higher and is much more stable than a conventional transmission jack. Mechanics can also utilize the device to work on transmission systems without bending over into awkward and uncomfortable positions. Thus, the device saves considerable time and effort when performing vehicle maintenance.

It will also be appreciated that there are a number of additional add-on features that can be incorporated into the device and moreover, the transmission hoist device can take many different forms as is known in the art.

In yet another embodiment, the transmission hoist device comprises a plurality of indicia.

In yet another embodiment, a method of conveniently performing transmission system maintenance using the transmission hoist device is disclosed. The method includes the steps of providing a transmission hoist device comprising a transmission jack with a sleeve, and an engine hoist with a boom. The method also comprises sliding the sleeve of the transmission jack into the boom of the engine hoist. Further, the method comprises tightening the sleeve securement knob. Next, the method comprises removing the transmission system from a vehicle. Further, the method comprises adjusting the working angle of the transmission system via the tilt adjustment knobs. Finally, the method comprises utilizing the transmission hoist device to perform transmission system maintenance.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the transmission hoist device of the present invention in accordance with the disclosed architecture;

FIG. 2 illustrates a perspective view of one embodiment of the transmission hoist device of the present invention showing the connection process of the device with an engine hoist in accordance with the disclosed architecture;

FIG. 3 illustrates a perspective view of one embodiment of the transmission hoist device of the present invention being used to remove the transmission of a vehicle in accordance with the disclosed architecture;

FIG. 4 illustrates a perspective view of one embodiment of the transmission hoist device of the present invention supporting a transmission system in accordance with the disclosed architecture;

FIG. 5 illustrates a mechanic performing maintenance on the transmission system supported by the transmission hoist device of the present invention in accordance with the disclosed architecture; and

FIG. 6 illustrates a flowchart showing the method of conveniently performing transmission maintenance utilizing the transmission hoist device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a transmission hoist device that provides users with a means to convert an engine hoist into a transmission jack. There is also a long felt need in the art for a transmission hoist device that can be elevated much higher and is much more stable than a conventional transmission jack. Further, there is a long felt need in the art for a transmission hoist device that enables mechanics to work on the transmission without bending over into awkward and uncomfortable positions. Finally, there is a long felt need in the art for a transmission hoist device that saves time and effort during vehicle maintenance work.

The present invention, in one exemplary embodiment, is a novel transmission hoist device for converting an engine hoist into a transmission jack. The transmission hoist device comprises a standard transmission jack with, for example, a 2″×2″ sleeve that slides onto the boom of an engine hoist. The steel sleeve features an adjustable plate to hold a transmission for removal, repair, and/or replacement. Thus, once the jack is connected to the hoist, the user can perform vehicle maintenance while saving considerable time and effort. The present invention also includes a novel method of conveniently performing transmission maintenance using the transmission hoist device. The method includes the steps of providing a transmission hoist device comprising a transmission jack with a sleeve, and an engine hoist with a boom. The method also comprises sliding the sleeve of the transmission jack into the boom of the engine hoist. Further, the method comprises tightening the sleeve securement knob. Next, the method comprises removing the transmission system from a vehicle. Further, the method comprises adjusting the working angle of the transmission system via the tilt adjustment knobs. Finally, the method comprises utilizing the transmission hoist device to perform transmission system maintenance.

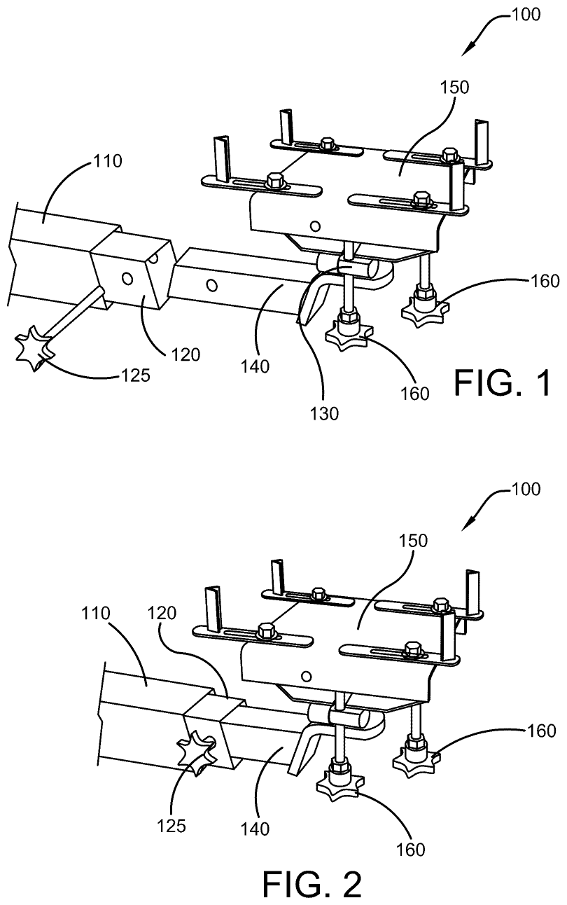

Referring initially to the drawings, FIG. 1 illustrates a perspective view of one embodiment of the transmission hoist device 100 of the present invention. In the present embodiment, the transmission hoist device 100 is an improved transmission hoist device 100 that provides a mechanic 300 with means of securing an engine hoist 130 to a transmission jack 110, creating one convenient tool. Specifically, the transmission hoist device 100 comprises a transmission jack 110 with, for example, a 2″×2″ sleeve 120 that is secured into the boom 140 of an engine hoist 130.

Generally, the transmission hoist device 100 of the present invention assists any setting in which vehicle maintenance is performed. The transmission jack device secures easily to an engine hoist and converts it into a transmission hoist. The transmission hoist device provides for a higher elevation that is much more stable than a conventional transmission jack. The transmission hoist device enables mechanics to work on the transmission without bending over into awkward and uncomfortable positions. The device saves considerable time and effort when performing vehicle maintenance.

As shown in FIG. 2, the transmission hoist device 100 comprises an adjustable plate 150. The adjustable plate 150 is typically configured in a rectangular (i.e., rectilinear) shape but can be configured in any suitable shape as is known in the art. A removed transmission system 250 is placed on the adjustable plate 150 for maintenance, repair, and/or replacement. FIG. 2 also illustrates the connection process between the sleeve 120 of the transmission jack 110 and the boom 140 of the engine hoist 130. The sleeve 120 encompasses the boom 140 and a sleeve securement knob 125 is tightened to hold the sleeve 120 around the boom 140.

Generally, the transmission hoist device 100 also comprises two tilt adjustment knobs 160 that can be used to modify the angle of the adjustable plate 150.

FIG. 3 illustrates a perspective view of one embodiment of the transmission hoist device 100 of the present invention being used to remove the transmission system 250 of a vehicle 200. The transmission system 250 is supported primarily by the adjustable plate 150.

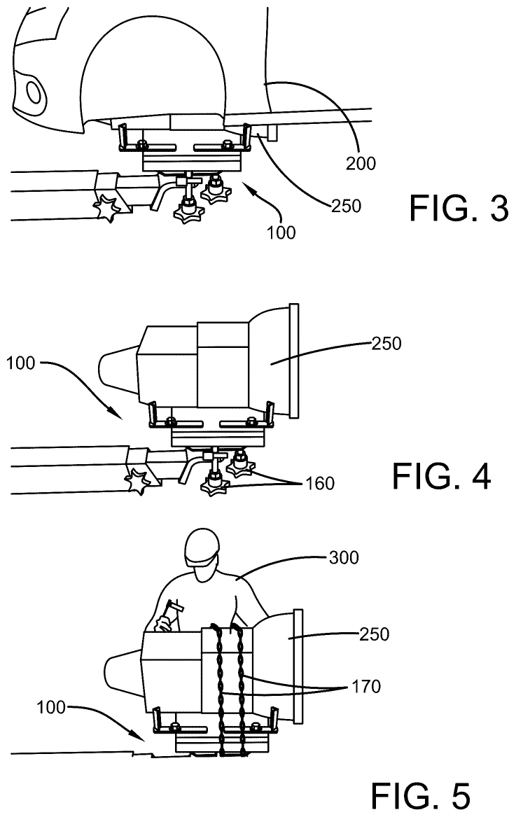

Shown in FIG. 4 is a perspective view of one embodiment of the transmission hoist device 100 of the present invention supporting a transmission system 250 that has been removed from a vehicle 200. In this position, a user can turn the tilt adjustment knobs 160 to tilt the adjustable plate 150 and transmission system 250 to a desirable (i.e., selectable) angle for the maintenance required. This alleviates awkward or uncomfortable bending of the user's body.

Further, and as shown in FIG. 5, the transmission hoist device 100 of the present invention includes chains 170 to further secure the transmission system 250 to the adjustable plate 150 while a mechanic 300 performs transmission maintenance.

As shown in FIGS. 1-5, in use, the mechanic 300 slides the sleeve 120 of the transmission jack 110 into the boom 140 of the engine hoist 130 and tightens the sleeve securement knob 125. The mechanic 300 then removes the transmission system 250 from a vehicle 200 and secures it to the adjustable plate 150 of the transmission hoist device 100. The mechanic 300 can then adjust the working angle of the transmission system 250 via the tilt adjustment knobs 160. Next, the mechanic 300 can utilize the chains 170 to further secure the transmission system 250 to the adjustable plate 150 and perform the required transmission maintenance. The transmission hoist device 100 can be elevated higher and is much more stable than a conventional transmission jack, enabling a mechanic 300 to work on the transmission system 250 without bending over into uncomfortable, awkward, or dangerous positions. Thus, the transmission hoist device 100 makes transmission maintenance safer, faster, and more convenient to complete than ordinary methods.

The transmission hoist device 100 in accordance with the present invention can be produced in various colors, designs, patterns, etc., and feature logos, emblems and or designs, such as a company requests and/or a mechanic 300 desires.

In one embodiment, the transmission hoist device 100 is manufactured of steel, or any other suitable materials as is known in the art. Any number of different types of materials can be used to make the transmission hoist device 100 including but not limited to carbon steel, iron, titanium, a variety of metal alloys, or any other suitable material as is known in the art.

In yet another embodiment, the transmission hoist device 100 comprises a plurality of indicia 400. The adjustable plate 150 of the device 100 may include advertising, a trademark, or other letters, designs, or characters, printed, painted, stamped, or integrated into the adjustable plate 150, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be vehicle or mechanic related.

It will also be appreciated that there are a number of additional add-on features that can be incorporated into the device 100 and moreover, the transmission hoist device 100 can take many different forms as is known in the art.

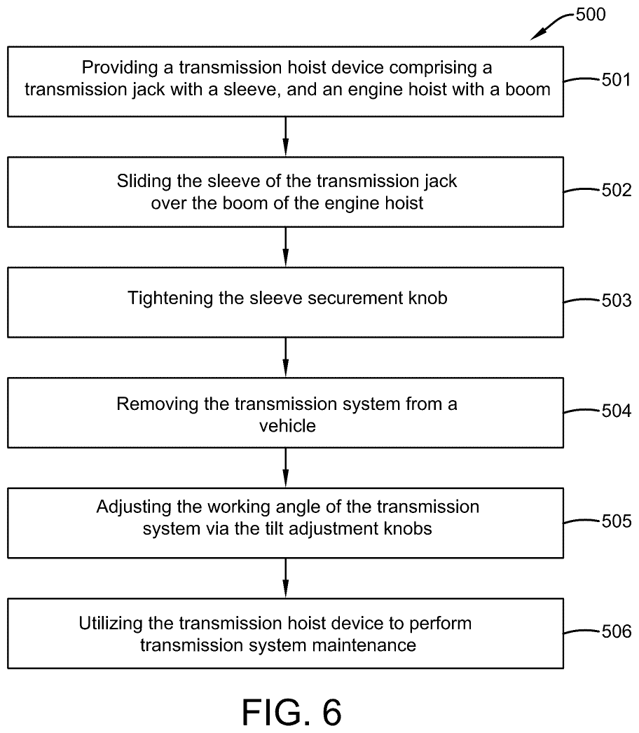

FIG. 6 illustrates a flowchart of the method 500 of conveniently performing transmission maintenance using the transmission hoist device. The method includes the steps of at 501, providing a transmission hoist device comprising a transmission jack with a sleeve, and an engine hoist with a boom. The method also comprises at 502, sliding the sleeve of the transmission jack into the boom of the engine hoist. Further, the method comprises at 503, tightening the sleeve securement knob. Next, the method comprises at 504, removing the transmission system from a vehicle. Further, the method comprises at 505, adjusting the working angle of the transmission system via the tilt adjustment knobs. Finally, the method comprises at 506, utilizing the transmission hoist device to perform transmission system maintenance.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “transmission hoist device”, “transmission device”, “hoist device”, and “device” are interchangeable and refer to the transmission hoist device 100 of the present invention.

Notwithstanding the forgoing, the transmission hoist device 100 of the present invention can be of any suitable size and configuration as is known in the art without affecting the overall concept of the invention, provided that it accomplishes the above stated objectives. One of ordinary skill in the art will appreciate that the transmission hoist device 100 as shown in FIGS. 1-6 is for illustrative purposes only, and that many other sizes and shapes of the transmission hoist device 100 are well within the scope of the present disclosure. Although the dimensions of the transmission hoist device 100 are important design parameters for user convenience, the transmission hoist device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A transmission hoist device comprising:
a transmission jack having a sleeve;
an engine hoist having a boom and an adjustable plate; and
a sleeve securement knob;
wherein said sleeve of said transmission jack is secured to said boom of said engine hoist;
wherein said sleeve securement knob is tightened to hold said sleeve to said boom for securing said transmission jack to said engine hoist; and
further wherein said transmission jack secured to said engine hoist for conversion into a transmission hoist.

2. The transmission hoist device of claim 1, wherein said engine hoist having a pair of tilt adjustment knobs to tilt said adjustable plate and a transmission mounted thereto to a selectable angle.

3. The transmission hoist device of claim 1, wherein said sleeve is a 2″×2″ sleeve.

4. The transmission hoist device of claim 2, wherein said adjustable plate is rectilinear.

5. The transmission hoist device of claim 4, wherein said sleeve slides into said boom.

6. The transmission hoist device of claim 5, wherein the transmission is supported by said adjustable plate therebelow.

7. The transmission hoist device of claim 6, wherein said engine hoist having a pair of chains for securing the transmission to said adjustable plate.

8. A transmission hoist device comprising:
a transmission jack having a sleeve;
an engine hoist having a boom and an adjustable plate; and
a sleeve securement knob;
wherein said sleeve of said transmission jack is secured to said boom of said engine hoist;
wherein said sleeve securement knob is tightened to hold said sleeve to said boom for securing said transmission jack to said engine hoist;
wherein said engine hoist having a pair of chains for securing the transmission to said adjustable plate;
wherein said engine hoist having a pair of tilt adjustment knobs to tilt said adjustable plate and a transmission mounted thereto to a selectable angle; and
further wherein said transmission jack secured to said engine hoist for conversion into a transmission hoist.

9. The transmission hoist device of claim 8, wherein said sleeve is a 2″×2″ sleeve.

10. The transmission hoist device of claim 9, wherein said adjustable plate is rectilinear.

11. The transmission hoist device of claim 10, wherein said sleeve inserted into said boom.

12. The transmission hoist device of claim 11, wherein the transmission is supported by said adjustable plate therebelow.

13. A method of converting and using a transmission hoist device, the method comprising the steps of:
providing a transmission jack having a sleeve, an engine hoist having a boom, an adjustable plate, and a sleeve securement knob;
securing said sleeve of said transmission jack into said boom of said engine hoist;
tightening said sleeve securement knob to hold said sleeve within said boom; and
securing said transmission jack to said engine hoist.

14. The method of converting and using a transmission hoist device of claim 13, wherein said transmission jack secured to said engine hoist for conversion into a transmission hoist.

15. The method of converting and using a transmission hoist device of claim 13, wherein said engine hoist having a pair of tilt adjustment knobs to tilt said adjustable plate and a transmission mounted thereto to a selectable angle.

16. The method of converting and using a transmission hoist device of claim 15, wherein said sleeve is a 2″×2″ sleeve.

17. The method of converting and using a transmission hoist device of claim 15, wherein said adjustable plate is rectilinear.

18. The method of converting and using a transmission hoist device of claim 15, wherein said sleeve slidable into said boom.

19. The method of converting and using a transmission hoist device of claim 16, wherein the transmission is supported by said adjustable plate therebelow.

20. The method of converting and using a transmission hoist device of claim 19, wherein said engine hoist having a pair of chains for securing the transmission to said adjustable plate.
